(19) United States
(12) Patent Application Publication
(10) Pub. No.: US 2020/0041457 A1
(43) Pub. Date: Feb. 6, 2020

(54) ACOUSTIC SENSOR ARRANGEMENT FOR DETECTING INSECTS IN CELLULOSE MATERIAL

(71) Applicant: FREEZEGUARD AB, Nacka Strand (SE)

(72) Inventors: Fredrik MAGNUSSON, Saltsjö-boo (SE); Gustav FRYKHOLM, Stockholm (SE)

(21) Appl. No.: 16/471,123

(22) PCT Filed: Dec. 13, 2017
(86) PCT No.: PCT/SE2017/051263

§ 371 Date: Jun. 19, 2019

(30) Foreign Application Priority Data
Dec. 19, 2016 (SE) 1651676-7

(51) Int. Cl. G01N 29/14; G01N 29/04; G01N 29/24; G01N 29/44

(52) U.S. Cl. CPC G01N 29/14; G01N 29/041; G01N 29/48; G01N 29/4454; G01N 29/2437

(57) ABSTRACT

The present invention relates to detector arrangement that is capable of monitoring vibrations within a construction (20) of an organic material. The detector arrangement (10) comprises an acoustic sensor and a processing unit (13) having a processor (14). An acoustic sensor monitors vibrations within the construction when mounted to the construction (20) and provides a signal based on said monitored vibrations. The processor (14) determines an intensity threshold based on the signal, and when the signal has a component with an intensity higher than the intensity threshold, the processor determines that insect infestation is detected in the construction, if the signal component has a certain frequency content, comprises a wave-form that is essentially that of insect infestation vibration, and has an intensity pattern over time, which intensity pattern indicates insect infestation. Else, the processor maintains the acoustic sensor to monitor vibrations.

### TECHNICAL FIELD

The present invention relates to a detector arrangement and in particular to a detector arrangement capable of monitoring vibrations within a construction of an organic material.

### BACKGROUND

Insects such as termites and in particular larvae thereof feed on cellulose material, and typically create foraging tubes in the cellulose material while feeding. In cellulose constructions, foraging tubes are clearly undesired since they considerably weaken the construction material. Entire constructions may for this reason fall down and risk people's life.

There are measures to prevent cellulose containing construction material from being consumed by insects. Poison and/or pesticides can be applied to the cellulose containing construction material. Such measures have however been questioned both for health reasons and for environmental reasons.

It is therefore a concern to try to detect presence of insects and in particular insect infestation in wooden material.

Insect infestation is often detected based on visual observation of indirect signs of infestation, such as foraging tubes, moisture stains and debris produced by termites. There are drawbacks by relying on visual observation of indirect signs.

Indirect signs are difficult to quantify, and are delayed with respect to a start of the insect infestation. Visual observation typically also requires a personal resource to observe the indirect signs.

D1 U.S. Pat. No. 4,895,025 A describes a destructive insect induced vibration detector, in which a comparison between vibrations, induced by feeding insects, and other records of known destructive insects, is made to determine probable species of insects and its location.

D2 WO 94/07114 A1 describes a system for detecting wood-destroying insect infestation in which an acoustic emission sensor is used. The system comprises indicating means for indicating to a user when an electrical signal provided by the acoustic emission sensor is caused by acoustic emission from wood-destroying insect infestation.

US 2007/0096928 A1 describes termite acoustic detection by which a thermal imaging camera is used to scan a structure before installing an acoustic sensor to locate areas of termite infestation.

The inventor of the present invention has identified a need for an improved technique circumventing or at least diminishing issues associated with prior art detection methods.

### SUMMARY

It is an object of exemplary embodiments herein to address at least some of the issues outlined above and to detect insect infestation of a construction of an organic material. This object and others are achieved by a detector arrangement capable of monitoring vibrations in organic materials, according to the appended independent claim, and by the exemplary embodiments according to the dependent claims.

According to an aspect, the exemplary embodiments provide a detector arrangement that is capable of monitoring vibrations within a construction of an organic material. The detector arrangement comprises an acoustic sensor and a processing unit. The processing unit comprises a processor, and is adapted to be connected to the acoustic sensor. The acoustic sensor is adapted to be mounted to the construction, and to monitor the vibrations within the construction when the acoustic sensor is mounted to the construction and to provide a signal based on said monitored vibrations. The processing unit is adapted to receive the signal from the acoustic sensor, and to determine an intensity threshold based on the received signal. The processing unit is adapted to determine that insect infestation is detected in the construction, when the received signal comprises a component having an intensity higher than the intensity threshold, and when the signal component has a frequency within a certain frequency interval, the signal component comprises a wave-form that is essentially that of insect infestation vibration, and the signal component has an intensity pattern over time, which intensity pattern indicates insect infestation. Else, the processing unit is adapted to maintain the acoustic sensor monitoring the vibrations.

It is an advantage that the detector arrangement enables insect infestation to be detected at an early stage before severe damages are caused in a construction of an organic material.

A further advantage of the detector arrangement is that the signal from picked-up vibrations is processed within the detector arrangement, and the determination that insect infestation is detected is made internally, i.e. within the detector arrangement, without the need to send or distribute potentially large amounts of data to devices or units external to the detector arrangement. This saves electric power, as compared to sending larger amounts of data for processing purposes, why this detector further is adapted to monitor vibrations in constructions of an organic material.

It is also an advantage that the present detector arrangement can be easily mounted and installed, for which reason mounting and installation is doable by a layman. The monitoring of the vibrations is preferably an on-going activity, and may thus be realized by an acoustic sensor that is adapted to continuously monitor the vibrations within a construction.

This is in contrast to most prior art techniques which require mounting, installation, measuring, and dismounting for each measurement session, for which reason each such measurement session may be considered to be a selective or isolated measure.

### BRIEF DESCRIPTION OF THE DRAWINGS

Embodiments will now be described in more detail, with reference to the accompanying drawings.

FIG. 1 schematically illustrates a detector arrangement capable of monitoring vibrations within a construction.

FIG. 2 schematically illustrates a detector arrangement, with its acoustic sensor in mechanical contact with a construction.

FIG. 3 schematically illustrates one example of a construction with which two detector arrangements are in mechanical contact.

### DETAILED DESCRIPTION

Insects such as termites can cause considerable damages to cellulose containing material. This is due to that they, and in particular larvae thereof, can feed on the cellulose containing material. From feeding foraging tubes are created in the material.

It is difficult to detect insect infestation by visual inspection of the material, at least at an early stage of infestation, since visual inspection has to rely on indirect signs of the insect infestation. This signs may comprise foraging tubes, moisture stains and debris produced by insects.

Inspections may be performed on a regular basis, such as annually. Performing regular inspections is wise, but inspecting, for instance, once a week, becomes awkward. Annual inspections or the like may be revealed to be too seldom, with the risk of detecting an already progressed insect infestation.

The present disclosure presents a detector arrangement that is capable of monitoring constructions of organic materials, such as cellulose containing materials.

It is advantageous to monitor vibrations within a construction, since insect infestation can be detected as it starts to develop. The insect infestation can thus be detected at an early stage, before it has caused severe damages to the construction. Detecting insect infestation at an early stage avoids severe damages and therefore reduces costs for repairing of occurred damages.

When detecting insect infestation at an early stage while the construction is essentially undamaged, it may be sufficient to treat the construction to get rid of the insects without requiring performing expensive repairing of the construction. Method to treat constructions to get rid of insects is outside the scope of this invention and will not be discussed further.

It is thus herein proposed to monitor a construction of organic materials. Monitoring is advantageous started while a construction is being constructed and may continuous during the entire lifetime of the construction.

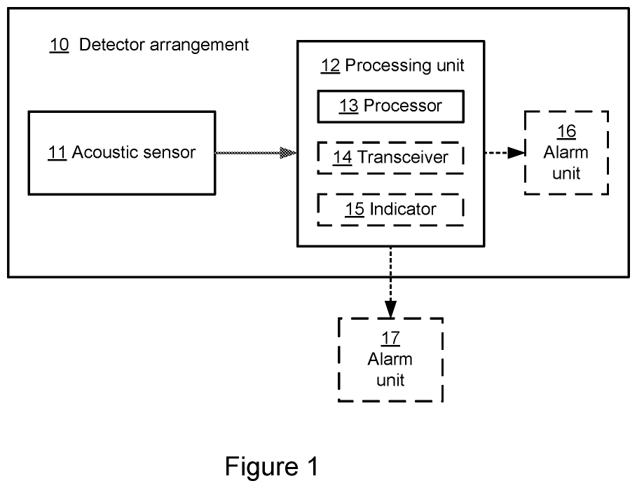

FIG. 1 schematically illustrates a detector arrangement 10 that is capable of monitoring vibrations within a construction, according to embodiments of this disclosure.

The detector arrangement 10 comprises an acoustic sensor 11 and a processing unit 13, where the processing unit 13 is adapted to be connected to the acoustic sensor 11.

This acoustic sensor may be an acoustic microphone or a piezo-electric sensor. The piezo-electric sensor may comprise a piezo-film sensor or a piezo-element sensor. The acoustic microphone may be contact microphone.

The acoustic sensor 11 is adapted to be mounted to the construction 20.

The acoustic sensor 11 is adapted to monitor the vibrations within the construction, and when being mounted to the construction 20, to provide a signal based on said monitored vibrations.

Preferably, the acoustic sensor 11 is adapted to continuously monitor the vibrations within the construction. Monitoring vibrations within the construction is thus preferably an on-going activity.

The processing unit 13 comprises a processor 14.

The processing unit 13 is adapted to receive the signal from the acoustic sensor 11. The processor 14 is adapted to determine an intensity threshold based on the received signal. When the received signal comprises a component that has an intensity higher than the intensity threshold, the processor 14 is further adapted to determine that insect infestation is detected in the construction, when the signal component has a frequency within a certain frequency interval, the signal component comprises a wave-form that is essentially that of insect infestation vibration, and the signal component has an intensity pattern over time, which intensity pattern indicates insect infestation.

The processor 14 is else adapted to maintain the acoustic sensor monitoring the vibrations.

Phrased differently, when the received signal has a component that has an intensity higher than the intensity threshold, the processor is configured to determine that insect infestation is detected in the construction, when the signal component has a frequency within a certain frequency interval, and when the signal component comprises a wave-form that is essentially that of insect infestation vibration, and when the signal component has an intensity pattern over time, which intensity pattern indicates insect infestation.

When the received signal has a component that has an intensity higher than the intensity threshold, but when the signal component does not have a frequency within the certain frequency interval, and/or the signal component does not comprise a wave-form that is essentially that of insect infestation vibration, and/or when the signal component does not have an intensity pattern over time, which intensity pattern indicates insect infestation, the processor is adapted to continue monitoring the vibrations using the acoustic sensor.

The organic material which the construction is made of, may contain cellulose, be wood or a material that is based on wood.

The intensity pattern of the signal component may be repetitive in time.

Insects, or rather larvae thereof, generate noise when feeding. This noise may be due to that wooden fibres are cracked by the larvae during their feeding, for instance during collecting of fibres and/or chewing of collected fibres.

The acoustic sensor of the detector arrangement may be adapted to be firmly attached to the construction. The acoustic sensor may also be adapted to be mounted into mechanical contact with the construction.

The mechanical contact into which the acoustic sensor can be mounted with the construction may comprise a direct contact. A direct contact between the acoustic sensor and the construction is here envisaged.

The mechanical contact, into which the acoustic sensor can be mounted with the construction, may comprise an invasive contact. An invasive contact may comprise contact between the construction and a nail, a bolt, or other means penetrating into the construction from the acoustic sensor.

Mounting of the insect indicator onto a construction, when made of wood, may be performed by placing the acoustic sensor perpendicular to the fibres of the wood. In such a position, the acoustic sensor is typically directed in the fibre direction of the wood. It is known that vibrations typically propagate at a higher velocity along the fibre direction than across the fibre direction. For this reason, it may be an advantage to mount the acoustic sensor at an end surface of a piece of wood being elongated in the fibre direction.

The acoustic sensor 11 may be an acoustic microphone or a piezo-electric sensor.

The acoustic microphone may be a contact microphone, and the piezo-electric sensor may be a piezo-film sensor or a piezo-element sensor. These acoustic sensors are sensitive to vibrations and are therefore suited for picking up vibrations in that they may generate an electric signal while monitoring the vibrations. Monitoring of vibrations thus generates an electric signal, which may be continuous, and therefore may need to be continuously processed. More about processing of a detected signal will be presented below.

The processing unit 13 of the detector arrangement 10 may also comprise an indicator 16 that is adapted to indicate that insect infestation is detected in the construction, when being activated by the processor. This indicator may be a light emitting diode (LED).

The acoustic sensor 11 and the processing unit 13, as comprised within the detector arrangement 10, are adapted to be connected to each other.

As described above, the acoustic sensor is adapted to be mounted to the construction. However, the processing unit may reside nearby the acoustic sensor, and having a wired connection between the processing unit and the acoustic sensor.

It is pointed out that more than a single acoustic sensor can be connected to one and the same processing unit for each detector arrangement. Using multiple acoustic sensors may further assist detecting insect infestation, since each acoustic sensor may be optimized according to local properties of the construction material.

The detector arrangement 10 may also comprise an alarm unit 17 that is adapted to emit an audio signal or a visual signal when being activated by the processor, upon determining that insect infestation has been detected in the construction. The processor is thus also adapted to activate this alarm unit.

For the purpose of sending an activation message, determined by processor 14, to the alarm unit 17, the detector arrangement 10 may comprise a transceiver 15 connected to the processor 14. When the processor determines that insect infestation is detected, the processor 14 may thus activate the alarm unit 17 via the transceiver 15. Upon determination by the processor that insect infestation is detected in the construction, the processor may be considered to activate the transceiver to send an activation message to the alarm unit 17. The transceiver 15 may upon activation send this activation message to the alarm unit 17, which upon receipt of said message, becomes activated.

The processor may alternatively activate an alarm unit 18 that is external to the detector arrangement 10. In this case, the processor activates said alarm unit 18 when it determines that insect infestation is detected. This external alarm unit 18 may be comprised in a mobile phone, smart watch, or the like.

The transceiver 15 may be a radio transceiver or a wireless transceiver. The activation message may be transmitted as a radio signal, a Bluetooth™ signal, or any other type of wireless signal.

Also, the transceiver 15 may be divided into a receiver and a transmitter.

The external alarm unit 18 is thus adapted to reside remotely in relation to the detector arrangement. This is in contrast to alarm unit 17, as described above, which is comprised with the detector arrangement. However, this does not mean that alarm unit 17 and the processing unit 13, or acoustic sensor 11, need to reside close to one another. Rather they may be separated by ca. 10-50 m from each other, still belonging to the same detector arrangement.

Similar to above, the alarm unit 18 may emit an audio signal or a visual signal upon activation by the processor, upon determining that insect infestation has been detected in the construction.

The present detector arrangement is considered to be suited for detecting termite infestation, in that the termite larvae feed on organic materials, especially cellulose containing materials.

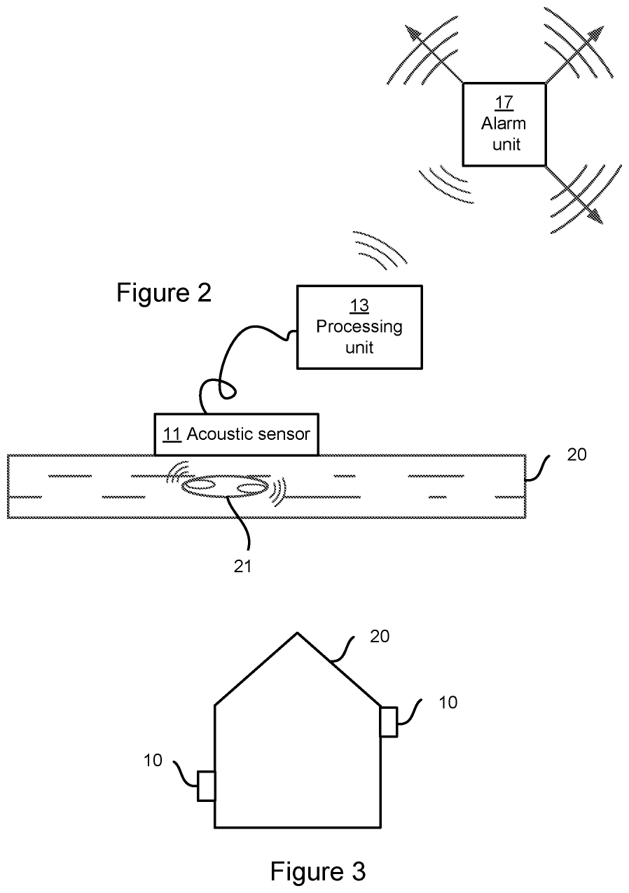

FIG. 2 is a schematic illustration of one example of a detector arrangement that comprises an acoustic sensor 11 and a processing unit 13. In this figure, it is schematically illustrated that the acoustic sensor 11 is in mechanical contact with a construction 20 of a wooden based material. Within the construction 20, an on-going insect infestation 21 is schematically indicated. Since insects, or rather larvae thereof, generate noise or vibrations while feeding; this insect infestation 21 is also illustrated to generate vibrations within the construction.

These vibrations being generated by the larvae when feeding can be picked up by the acoustic sensor 11. The insect indicator forwards a signal that is based on the vibrations being monitored.

The processing unit 13 typically comprises a processor 14 that is adapted to process the signal as received from the acoustic sensor 11.

The processing unit may comprise a pre-amplifier and an analogue band pass filter. The pre-amplifier is adapted to amplify the received signal. When the received signal is amplified it may thus be subjected to the analogue band pass filter to reduce influences of disturbing signals. Disturbing signals may be due to human activities and/or vibrations or noise created outside the construction, but propagated into the construction.

The band pass filter is typically adapted to attenuate low frequencies and high frequencies, whereas intermediate frequencies are passed essentially without being attenuated.

The processor 14 may then convert the amplified and potentially filtered signal from the analogue domain to the digital domain, by using an analogue to digital converter (ADC) function.

The processor 14 is preferably adapted to determine an intensity threshold based on the thus obtained digital signal, as originated from the acoustic sensor. The processor is further adapted to determine the intensity threshold without the need of any input from an operator or mounting technician or engineer. This means that the processor is configured to adapt the intensity threshold according to the signal currently being picked-up and that said adaptation of the intensity threshold in this respect can be considered to be automated. This is advantageous since the processor will be able to determine an intensity threshold based on local noise and vibrations which may give rise to vibrations within the construction.

The intensity threshold is preferably defined at an intensity level such that signals having an intensity level below said intensity threshold are disregarded and not considered and therefore do not require any further analysis or processing.

In contrast, signals having an intensity equal to or above the intensity threshold are considered and are subjected to further analysis and processing by the processor.

According to one embodiment of the detector arrangement, the processor 14 is adapted to operable in two different operation modes, one being a stand-by mode and the other being an active or powered operation mode. While the processor is operated in the stand-by mode, the processor is adapted to determine whether the signal as received from the acoustic signal, and after having passed a pre-amplifier, has a component that has an intensity higher than the intensity threshold, or not.

During time intervals in which the monitored signal does not comprise any components having an intensity level higher than the intensity threshold, the processor is operated in the stand-by mode. While the monitored signal only has one or more components having an intensity signal lower than the intensity threshold, it is thus sufficient to operate the processor in the stand-by mode.

The energy consumption of the processor is lower in the stand-by mode, as compared to the energy consumption is the active or powered mode. In this respect, the detector arrangement may save energy which is an advantage for detector arrangements capable of monitoring vibrations in constructions of organic materials and adapted for long-term monitoring of said vibrations.

When the processor determines that the signal comprises one or more components having an intensity level higher that the intensity threshold, these signal components are subjected to further analyses and processing. In such a case the processor is typically operated in the active or powered mode.

Further, when having identified one or more components having an intensity level higher than, or equal to, the intensity threshold, the processor is adapted to determine whether the component(s) comprise(s) at least one signal component having a frequency within a certain frequency interval. It is thus determined whether the component(s) comprises a frequency within a frequency range that is particular interest when detecting insect infestation. It is envisaged that certain insects feed in such a way that vibrations having a certain frequency or certain frequencies. The frequency or frequencies may form a frequency content and this may vary from one insect type to another.

The processor may further be adapted to analyse an envelope or wave of the one or more signal components. The processor may hence be adapted to determine an envelope or wave form of the one or more signal components, and determine whether one or both of these is/are typical to that/those of insect infestation, or not.

When the processor determines that the envelope or wave form or wave form of the one or more signal components, is typical to that/those of insect infestation, the processor may further be adapted to analyse an intensity pattern over time of the signal component(s).

An intensity over time may be an intensity pattern with a plurality of intensity peaks. These peaks may occur may be repetitive in nature.

The processor is preferably adapted to determine whether the intensity pattern is typical to insect infestation.

Intensity patterns of independently identified insect infestation may be recorded and stored in the processing unit, being available to the processor when determining whether infestation is detected in the construction, or not.

Eventually, the processor may thus be adapted to analyse the intensity pattern over time, and when the one or more signal component(s) has/have an intensity pattern over time, which intensity pattern indicates insect infestation, the processor determines that insect infestation is detected in the construction.

An intensity pattern indicating insect infestation may comprise one or more, bands or intervals, of repetitive intensity peaks.

Also, when the signal component(s) do/does not correspond to those of insect infestation, the processor may be adapted instruct the detector to continue monitoring the vibrations.

In line with the detector arrangement being capable of monitoring vibrations in a construction, the detector arrangement is suited for real-time monitoring and real-time activating an indicator or alarm unit, when it is determined that insect infestation has been detected. Monitoring of the vibrations is an on-going process and may be continued, even after the processor has determined that insect infestation has been detected.

Further with reference to FIG. 2, when the processor has determined that insect infestation is detected, it may send an activation message to the alarm unit 18, which activation message is designed to activate the alarm unit 18 to emit an audio signal or a visual signal, to give notice about that insect infestation is detected in the construction.

FIG. 3 schematically illustrates one example of a construction having attached two detector arrangements mounted in mechanical contact with the construction. This figure is not to be interpreted as to show or even indicate a particularly suitable position where to mount a detector arrangement. However, acoustic sensors of said detector arrangements may be mounted at a large number of places, at which each acoustic sensor is preferably mounted in mechanical contact with the construction in which vibrations are to be monitored.

It is an advantage that the present detector arrangement can be easily mounted and installed, for which reason mounting and installation is doable by a layman. This is in contrast to most prior art techniques which require repeated mounting, installation, measuring, and dismounting where each measurement session may be considered to be a selective or isolated measure.

It is a further advantage that the detector arrangement enables insect infestation to be detected at an early stage before severe damages are caused in a construction of an organic material.

A further advantage of the detector arrangement according to embodiments of the present disclosure is that the signal from picked-up vibrations is processed within the detector arrangement, and the determination that insect infestation is detected is made internally, i.e. within the detector arrangement, without the need to send or distribute potentially large amounts of data to devices or units external to the detector arrangement. This saves electric power, as compared to sending larger amounts of data for processing purposes, why this detector further is adapted to monitor vibrations in constructions of an organic material.

The present invention is not limited to the above-described preferred embodiments. Various alternatives, modifications and equivalents may be used. Therefore, the above embodiments should not be taken as limiting the scope of the invention, which is defined by the appending claims.

1. A detector arrangement capable of monitoring vibrations within a construction of an organic material, wherein the detector arrangement comprises:
an acoustic sensor; and
a processing unit comprising a processor, where the processing unit is adapted to be connected to the acoustic sensor;
where the acoustic sensor is adapted to be mounted to the construction and to continuously monitor the vibrations within the construction when the acoustic sensor is mounted to the construction and to provide a signal based on said monitored vibrations; and
where the processing unit is adapted to receive the signal from the acoustic sensor,
where the processor is adapted to determine an intensity threshold based on the received signal, and when the received signal comprises a component having an intensity higher than the intensity threshold, and
when
the signal component has a frequency within a certain frequency interval,
the signal component comprises a wave-form that is essentially that of insect infestation vibration, and
the signal component has an intensity pattern over time, which intensity pattern indicates insect infestation, further be adapted to determine that insect infestation is detected in the construction;
else
be adapted to maintain the acoustic sensor monitoring the vibrations.

2. The detector arrangement according to claim 1, wherein the intensity pattern indicating insect infestation is repetitive in time.

3. The detector arrangement according to claim 1, wherein the acoustic sensor is adapted to be firmly attached to, and/or be mounted into mechanical contact with, the construction.

4. The detector arrangement according to claim 1, wherein the acoustic sensor is adapted to be mounted into mechanical contact with the construction.

5. The detector arrangement according to claim 4, wherein the mechanical contact with said construction comprises a direct contact to or an invasive contact with, said construction.

6. The detector arrangement according to claim 1, wherein the processing unit comprises an indicator, and wherein the processor is adapted to activate the indicator, when determined that insect infestation is detected in the construction.

7. The detector arrangement according to claim 1, wherein the processor further is adapted to activate an alarm unit, when determined that insect infestation is detected in the construction.

8. The detector arrangement according to claim 7, wherein the processing unit comprises a transceiver that is connected to the processor, via which the processing unit is adapted to activate the alarm unit.

9. The detector arrangement according to claim 7, wherein the alarm unit is adapted to emit an audio signal when activated.

10. The detector arrangement according to claim 7, wherein the alarm unit is adapted to produce a visual signal when activated.

11. The detector arrangement according to claim 7, wherein the alarm unit comprises a first alarm unit that is adapted to reside within the detector arrangement.

12. The detector arrangement according to claim 7, wherein the alarm unit comprises a second alarm unit that is adapted to reside remotely in relation to the detector arrangement.

13. The detector arrangement according to claim 8, wherein said transceiver is a radio transceiver or a wireless transceiver.

14. The detector arrangement according to claim 1, wherein the acoustic sensor is an acoustic microphone or a piezo-electric sensor.

15. The detector arrangement according to claim 14, wherein the piezo-electric sensor is a piezo-film sensor or a piezo-element sensor.

16. The detector arrangement according to claim 14, wherein the acoustic microphone is a contact microphone.
